(19) United States
(12) Patent Application Publication
(10) Pub. No.: US 2013/0166525 A1
(43) Pub. Date: Jun. 27, 2013

(54) PROVIDING APPLICATION RESULTS BASED ON USER INTENT

(71) Applicants: FELIPE LUIS NARANJO, SEATTLE, WA (US); TIMOTHY MATTHEW EDGAR, BELLEVUE, WA (US)

(72) Inventors: FELIPE LUIS NARANJO, SEATTLE, WA (US); TIMOTHY MATTHEW EDGAR, BELLEVUE, WA (US)

(73) Assignee: MICROSOFT CORPORATION, REDMOND, WA (US)

(21) Appl. No.: 13/337,947

(22) Filed: Dec. 27, 2011

(51) Int. Cl. G06F 17/30

(52) U.S. Cl. 707/706; 707/723; 707/E17.108

(57) ABSTRACT

Methods, computer systems, and computer-readable storage media for providing application results related to user intent with respect to a topic-of-interest are provided. A user search session is monitored and upon discerning a requisite level of user intent with respect to the topic-of-interest, applications residing on the user device that provide application results related to the user intent are determined. A request for the application results is communicated to the applications, and the applications results are received from at least a portion of the applications. The application results are integrated with a set of Web-based results; the results are ranked and are presented on a user interface.

### BACKGROUND

Applications, or apps, are continually being developed to fulfill users' tasks. In order for a user to take advantage of an application's capabilities, the user downloads the application to a device and then launches the application. Currently, there is no effective way to harness the different capabilities of applications present on the user's device in the context of an Internet search session. In other words, a user who has initiated a search session with respect to a topic-of-interest is typically presented solely with Web-based results. Gathering results from applications present on the user's device can help to more heartily answer the user's intent with respect to the topic-of-interest.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, broadcasting user intent related to a topic-of-interest to applications residing on the user's device, and, in turn, receiving application results which are presented to the user in conjunction with Web-based results. The result is a more comprehensive set of results as compared to Web-based results generated from a typical search session.

The terms “applications” and “apps” are used interchangeably herein and broadly pertain to application software designed to be executed by an operating system hosted on a computing device and to assist the user in performing specific tasks. In operation, applications provide digital solutions in the real world, such as word processing, gaming, communication-based interfaces, etc. Examples of applications include enterprise software, accounting software, office suites, graphics software, and media players and include such popular applications as GROUPON®, SHAZAM®, OPENTABLE®, YELP®, and the like. It should be understood and appreciated that the definition of applications is not limited to the scope of examples provided herein and may include any code that carries out one or more operations when executed.

Accordingly, in one embodiment, the present invention is directed to one or more computer-readable storage media having embodied thereon computer-executable instructions that, when executed, perform a method of broadcasting high user intent with respect to a topic-of-interest to one or more applications residing on a user device. The method comprises monitoring a user search session on the user device to identify user intent with respect to the topic-of-interest. After identifying the user intent with respect to the topic-of-interest, it is determined that the user intent exceeds a predetermined threshold. Based on this, one or more applications residing on the user device that provide application results related to the user intent are determined. A request is communicated to the one or more applications for the application results; the application results are subsequently received from at least a portion of the one or more applications. The application results are integrated with a set of Web-based results to form an aggregate set of results; the set of Web-based results also relate to the user intent. The aggregate set of results is ranked and presented on a user interface display.

In another embodiment, the present invention is directed to a computerized method carried out by a search service running on a processor for broadcasting user intent with respect to a topic-of-interest to one or more applications residing on a user device. The method comprises receiving a user-initiated selection request for application results related to a topic-of-interest on a Web page that the user is currently viewing; the user-initiated selection request indicates user intent with respect to the topic-of-interest. Using the processor, one or more applications residing on the user device that provide application results related to the user intent are determined. A request is communicated to the one or more applications for the application results, and the application results are received from at least a portion of the one or more applications. The application results are integrated with a set of Web-based results to form an aggregate set of results; the set of Web-based results is also related to the user intent. The aggregate set of results is ranked and presented in a display area. The display area overlays at least a portion of content on the Web page the user is currently viewing.

In yet another embodiment, the present invention is directed to a computer system for providing application results related to a topic-of-interest. The computer system comprises a processing unit coupled to a computer-storage medium; the computer-storage medium has stored thereon a plurality of computer software components executable by the processing unit. The computer software components comprise a monitoring component for monitoring a user-initiated search session and identifying user intent with respect to the topic-of-interest. The components also comprise a search trigger identification component for identifying at least one search trigger related to the user intent, and an entity component for determining at least one application residing on the computer system that provides application results related to the user intent.

Continuing, the components also comprise a broadcasting component for communicating one or more requests to the at least one application for results related to the topic-of-interest, a Web browser, and one or more advertisers associated with the Web browser, and a receiving component for receiving the results related to the user intent. Additionally, the components comprise a ranking component for ranking the results, and a presentation component for presenting results on a user interface.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for providing application results related to a topic-of-interest suitable for use in implementing embodiments of the present invention;

FIG. 3 is a flow diagram that illustrates a method of broadcasting high user intent with respect to a topic-of-interest to applications residing on a user device in accordance with an embodiment of the present invention;

FIG. 4 is a flow diagram that illustrates a method of broadcasting user intent with respect to a topic-of-interest to applications residing on a user device in accordance with an embodiment of the present invention;

FIG. 5A is an exemplary user interface illustrating a Web page before a user-initiated selection request for application results in accordance with an embodiment of the present invention;

FIG. 5B is an exemplary user interface illustrating the Web page of FIG. 5A after a user-initiated selection request for application results in accordance with an embodiment of the present invention;

FIG. 6 is an exemplary user interface illustrating a Web page with application results after determining high user intent with respect to a topic-of-interest in accordance with an embodiment of the present invention; and

FIG. 7 is an exemplary user interface illustrating a notification display indicating the availability of an application that meets user intent with respect to a topic-of interest in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer-readable storage media for, among other things, broadcasting user intent related to a topic-of-interest to applications residing on the user's device, and, in turn, receiving application results from at least a portion of the applications and presenting the application results to the user in conjunction with Web-based results. In brief and at a high level, a user search session is monitored, and user intent with respect to a topic-of-interest is identified. The user intent is identified by either a user-initiated selection request for application results or by determining that the user intent exceeds a predetermined threshold based on user activity. After the user intent is identified, applications residing on the user's device that provide application results related to the user intent are determined, and a request for the application results is communicated to the applications. After receiving the application results from at least some of the applications, the applications results are aggregated with a set of Web-based results. The aggregate set of results is ranked and presented on a user interface display.

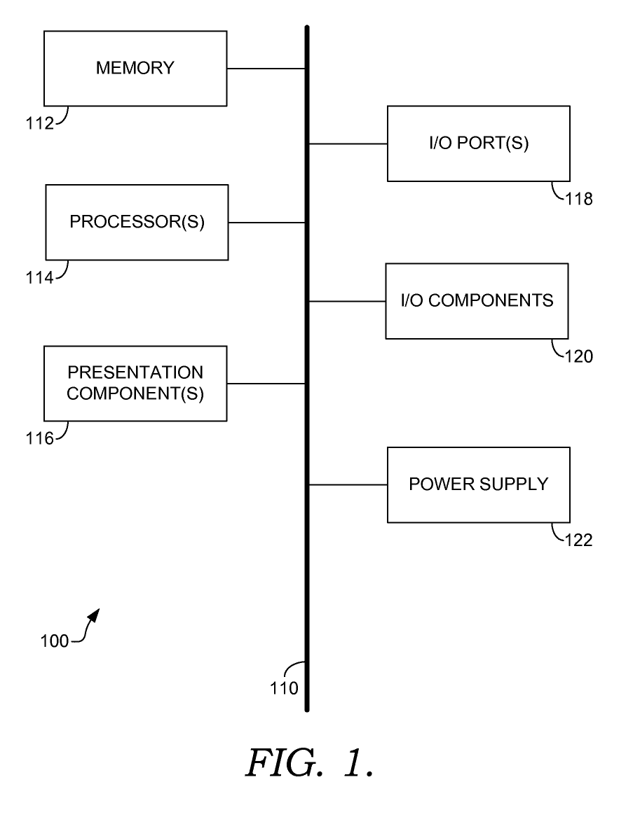

An exemplary computing environment suitable for use in implementing embodiments of the present invention is described below in order to provide a general context for various aspects of the present invention. Referring to FIG. 1, such an exemplary computing environment is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a Web browser, a set of one or more processes distributed on one or more computers, one or more stand-alone storage devices, a set of one or more other computing or storage devices, a combination of one or more of the above, and the like.

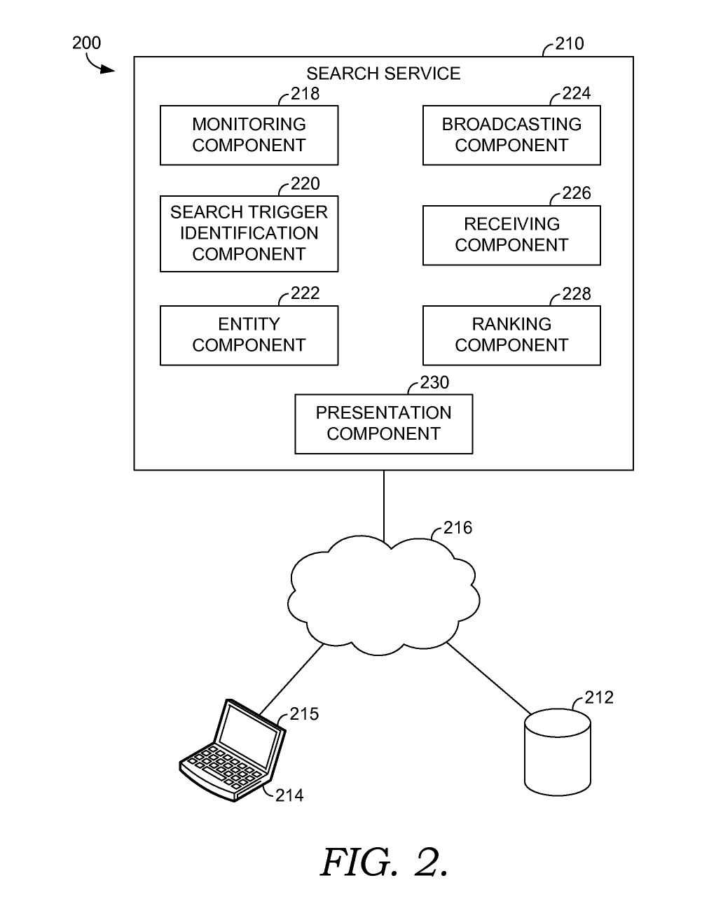

With this as a background and turning to FIG. 2, an exemplary system 200 is depicted for use in discerning user intent with respect to a topic-of-interest, broadcasting the user intent to applications residing on the user's device, and presenting application results related to the topic-of-interest. The system 200 is merely an example of one suitable system environment and is not intended to suggest any limitation as to the scope of use or functionality of embodiments of the present invention. Neither should the system 200 be interpreted as having any dependency or requirement related to any single module/component or combination of modules/components illustrated therein.

The system 200 includes a search service 210, a data store 212, and an end-user computing device 214 all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

In some embodiments, one or more of the illustrated components/modules may be implemented as stand-alone applications. In other embodiments, one or more of the illustrated components/modules may be integrated directly into, for example, the operating system of the end-user computing device 214 or the search service 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the search service 210 might reside on a server, a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 212 is configured to store information for use by, for example, the search service 210. The information stored in association with the data store 212 is configured to be searchable for one or more items of information stored in association therewith. The information stored in association with the data store 212 may comprise general information used by the search service 210. For example, the data store 212 may store information concerning recorded search behavior (e.g., query logs, related search lists, etc.) of users in general, and a log of a particular user's tracked interactions with the search service 210. As well, the data store 212 may store Web-based search results corresponding to any number of implicit or explicit search queries. The Web-based results may include standard search results as well as advertisements from advertisers associated with the search service 210.

The data store 212 may also store information concerning applications residing on a user's device such as the end-user computing device 214. Additionally, the data store 212 may include a mapping between the applications residing on the user's device and application capabilities. As used throughout this specification, application capabilities refer to the type of structured data subscribed to by any one application. In turn, the type of structured data subscribed to by an application determines whether the application can answer the user's intent with respect to a topic-of-interest. By way of illustrative example, the application YELP® provides restaurant reviews. Thus, YELP® subscribes to restaurant-related structured data and is able to answer user intent with respect to restaurant reviews.

The data store may also store user history and the history of users in general as it pertains to the applications residing on the user's device. For example, a purchasing history as it relates to the different applications residing on the user's device may be stored. Popularity information of the different applications may be stored as well as ratings from an application rating service. The data store 212 may also store information related to applications not currently residing on the user's device and the respective capabilities of those applications.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the search service 210, the end-user computing device 214, and/or any combination thereof.

The end-user computing device 214 shown in FIG. 2 may be any type of computing device, such as, for example, the computing device 100 described above with reference to FIG. 1. By way of example only and not limitation, the end-user computing device 214 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof. As shown, the end-user computing device 214 includes a display screen 215. The display screen 215 is configured to present information, including Web pages, notifications, application results, and/or Web-based results, to the user of the end-user computing device 214.

The system 200 is merely exemplary. While the search service 210 is illustrated as a single unit, it will be appreciated that the search service 210 is scalable. For example, the search service 210 may in actuality include a plurality of computing devices in communication with one another. Moreover, the data store 212, or portions thereof, may be included within, for instance, the search service 210 as a computer-storage medium. The single unit depictions are meant for clarity, not to limit the scope of embodiments in any form.

As shown in FIG. 2, the search service 210 comprises a monitoring component 218, a search trigger identification component 220, an entity component 222, a broadcasting component 224, a receiving component 226, a ranking component 228, and a presentation component 230. In some embodiments, one or more of the components 218, 220, 222, 224, 226, 228, and 230 may be implemented as stand-alone applications. In other embodiments, one or more of the components 218, 220, 222, 224, 226, 228, and 230 may be integrated directly into the operating system of a computing device such as the computing device 100 of FIG. 1. It will be understood that the components 218, 220, 222, 224, 226, 228, and 230 illustrated in FIG. 2 are exemplary in nature and in number and should not be construed as limiting. Any number of components may be employed to achieve the desired functionality within the scope of embodiments hereof.

The monitoring component 218 of FIG. 2 is configured to monitor a user's current search session on a user device to identify user intent with respect to a topic-of-interest. As used throughout this application, the term “search session” is meant to encompass any user activity related to the World Wide Web (the “Web”). For example, it may include a user visiting a search engine such as Bing® and entering a search query, receiving a set of results, and selecting one of the results in order to access a Web page. As well it may include a user inputting a uniform resource locator (URL) in a Web browser, such as Internet Explorer®, and accessing a Web page. Additionally, it may include a user selecting a hyperlink while visiting a Web page in order to access another Web page or navigating between different Web pages. These examples are provided for illustrative purposes only and are not meant to be limiting in any way.

The monitoring component 218 monitors the user's search session by monitoring Web pages (i.e., a uniform resource locator (URL) stream) viewed by the user and examining user activity on these Web pages. User activity may include link selections, dwell times, click-throughs, and/or other interactions with a Web page. This type of activity is known as implicit search activity. There is no need for the user to explicitly form a query. The monitoring component 218 may also be configured to access a log associated with the data store 212 that tracks user activities during previous search sessions.

Based on the monitoring activity, the monitoring component 218 is also configured to identify user intent with respect to a topic-of-interest. In one aspect, user intent with respect to the topic-of-interest may be found if the user has viewed the topic-of-interest on at least one Web page. For example, user intent with respect to a particular model of a television may be determined if the user has viewed at least one Web page that provides information about the particular model of the television. As well, user intent may be found if the user has user activity with respect to a Web page associated with the topic-of-interest (e.g., the user clicked on the topic-of-interest while viewing the Web page).

The monitoring component 218 is configured to determine a level of user intent with respect to the topic-of-interest. For example, a user who has viewed the topic-of-interest multiple times across multiple Web pages may be determined to have a higher level of user intent than a user who views the topic-of-interest only one time.

The search trigger identification component 220 is configured to identify at least one search trigger related to the user intent. In one embodiment of the invention, the search trigger comprises a user-initiated selection request. For example, a user may be viewing a Web page displaying a topic-of-interest. The user desires to view more results, including application results, related to the topic-of-interest and selects a control button located on a user interface associated with the Web page. This selection request is received by the search trigger identification component 220.

In another embodiment of the invention, the search trigger comprises user activity during the user search session that indicates a high degree of user intent with respect to the topic-of-interest. One example of a high degree of user intent is when the user views the topic-of-interest multiple times on the same Web page during the search session or when the user views the topic-of-interest multiple times on different Web pages during the search session. Another example of a high degree of user intent occurs when the topic-of-interest is a service and/or a tangible good and user activity indicates that the user is about to purchase the service and/or the tangible good. This may include, for instance, the user placing the product in a virtual shopping cart, or the user initiating the act of paying for the product on a checkout page of a Web site.

With continued reference to this embodiment, the search trigger identification component 220 may tailor a set of high user intent rules specific to the user based on user activity during previous search sessions (as stored in the data store 212). For example, user activity during previous search sessions may indicate that the user has a strong history of purchasing a topic-of-interest after spending a certain amount of time at a Web site viewing or interacting with the topic-of-interest. Based on this, the search trigger identification component 220 may identify a high degree of user intent once the user has viewed or interacted with a topic-of-interest on a Web page for a predetermined period of time. As well, user activity during previous search sessions may indicate that the user has a strong history of purchasing goods from a certain category of goods (for example, sporting goods). Based on this, the search trigger identification component 220 may identify a high degree of user intent once the user starts to view a Web page associated with sporting goods. Additionally, user activity during previous search sessions may indicate that certain uniform resource locator (URL) streams have led to results that have been acted upon by the user. Based on this, the search trigger identification component 220 may identify a high degree of user intent when that particular URL stream occurs during the user's current search session. Many other examples exist where user activity during previous search sessions may be utilized to tailor a set of high user intent rules specific to the user; these examples are within the scope of embodiments of this invention.

The entity component 222 is configured for determining at least one application residing on the user's device that provides application results related to the user intent with respect to the topic-of-interest. For the purposes of this specification, the term “residing on the user's device” is synonymous with the application software being executed by the operating system hosted on the user's device. The entity component 222 does this by accessing the data store 212. As mentioned above, the data store 212 includes a mapping between the applications residing on the user's device and application capabilities. The entity component 222 compares the user intent with respect to the topic-of-interest against the application capabilities to determine a match. For example, a match may be determined if the user intent is a desire to obtain a restaurant review and application capabilities relate to structured data dealing with restaurant reviews. Continuing, when a match exists between the user intent and application capabilities, the one or more applications associated with the matched application capabilities are determined.

In one aspect of the invention, the entity component 222 is also configured to identify one or more applications relevant to the user intent but that are not installed on the user's device. Again, the entity component 222 may access the data store 212 to determine if the user intent matches application capabilities of applications not currently residing on the user's device. If the user intent matches one or more application capabilities, the applications associated with the application capabilities are identified. This information may be used to prompt the user to install the application. This aspect will be covered in greater depth below.

The broadcasting component 224 is configured for communicating one or more requests for application results related to the user intent with respect to the topic-of-interest. Requests for application results may be communicated to the applications determined by the entity component 222. Additionally, requests for Web-based results that are also targeted to the user intent may be communicated to a search engine or Web browser associated with the search service 210. The Web-based results may include standard search results as well as advertisements from one or more advertisers associated with the search engine and/or Web browser. Additionally, a request may be communicated to the data store 212 for Web-based results targeted to the user intent.

The receiving component 226 is configured to receive the results related to the user intent with respect to the topic-of-interest. The results may comprise application results from the one or more applications residing on the user's device, and the Web-based results that include advertisements. The receiving component 226 is also configured to aggregate the application results with the Web-based results to form an aggregate set of results.

The ranking component 228 is configured for ranking results. In one aspect of the invention, the ranking component 228 is configured to rank the application results before they are aggregated with the Web-based results. The application results may be ranked based on, for example, a number of purchases by the user and/or by the general population from the respective applications, a popularity of the respective applications, a rating from an application rating service for the respective applications, and/or additional factors that measure the relevance of an application. The information used by the ranking component 228 to rank the application results may be stored in the data store 212.

In another aspect of the invention, the ranking component 228 is configured for ranking the aggregate set of results (i.e., the application results and the Web-based results). The aggregate set of results may be ranked based on a click-through rate of the each result. The click-through rate provides an indication of how many times the user or users in general have clicked on a particular Web result, an advertisement, or an application result. Other ranking metrics may include a conversion history for each of the results, a view-through rate, a click-through interest, and the like. Any and all such variations are within the scope of embodiments of the invention.

Still further, the ranking component 228 may be configured for ranking applications that are relevant to the user intent with respect to the topic-of-interest but are currently not residing on the user's device. These applications may be ranked on, for example, how closely the application matches the user intent with respect to the topic-of-interest, popularity, ratings, and the like.

The presentation component 230 is configured for presenting the aggregate set of results on a user interface. The user interface overlays at least a portion of content on a Web page currently being viewed by the user. The presentation component 230, in one aspect, presents the top four to six ranked results. Each result may be presented in a separate area of the user interface and may include textual elements, images, ratings, and the like. Further, each result may have a selectable control with which it is associated. Upon user selection of the selectable control, the result may be launched by a launching component of the search service 210 (not shown). For example, if the user selects an application result, a user interface associated with the application will launch and will overlay at least a portion of the content of the Web page currently being viewed. Further, instead of launching to a homepage of the application, a specific feature associated with the topic-of-interest will be launched within the application enabling the user to immediately view pertinent results related to the topic-of-interest. With respect to the Web-based results, clicking on these results will also launch a user interface associated with the topic-of-interest. Again, the user interface overlays at least a portion of the content of the Web page currently being viewed by the user and presents information related to the topic-of-interest.

The presentation component 230 is also configured for presenting a notification user interface display that prompts the user to install an application that is not currently residing on the user's device but that is relevant to the user intent with respect to the topic-of-interest. The notification user interface display overlays at least a portion of content of a Web page that is currently being viewed by the user. The presentation component 230 may present one or more notifications for one or more applications in the notification user interface display area; the notifications may be presented in a ranking order as determined by the ranking component 228. The notifications may comprise textual elements, images, ratings, and the like. As well, the notifications may have an associated selectable control that, when selected by the user, auto-installs the application and launches the application. Like above, a specific feature associated with the topic-of-interest will be launched within the application enabling the user to immediately view pertinent results related to the topic-of-interest.

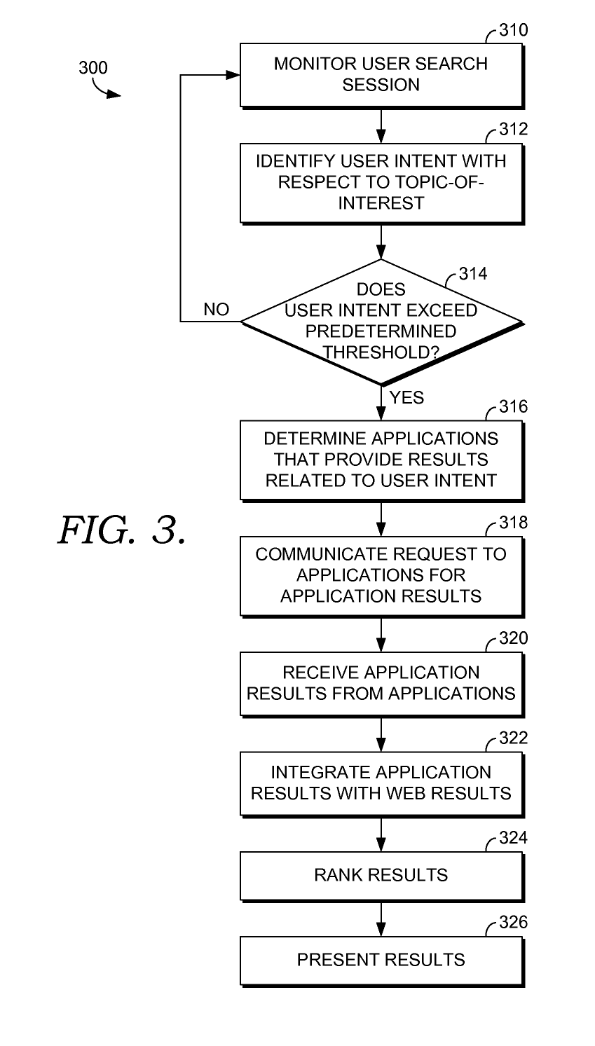

Turning now to FIG. 3, a flow diagram is depicted of a method 300 of broadcasting high user intent with respect to a topic-of-interest to applications residing on a user device and receiving a set of application results. At step 310, a user begins an implicit search session, and the user search session is monitored by, for example, a monitoring component such as the monitoring component 218 of FIG. 2. Web pages viewed by the user as well as user activity on those Web pages are monitored to determine if there is user intent with respect to a topic-of-interest.

At step 312, user intent with respect to a topic-of-interest is identified. For example, the user may have clicked on a topic-of-interest on a particular Web page, or the user may have hovered over a topic-of-interest on one or more Web pages. At step 314, a determination is made whether the user intent exceeds a predetermined threshold. As mentioned above, this may be determined if the user views the topic-of-interest on a predetermined number of Web pages, or viewed the topic-of-interest a predetermined number of times on the same Web page. Other examples may include user activity indicating that the user is getting ready to purchase the topic-of-interest (e.g., the user is on a checkout page of a Web site and has begun paying for the topic-of-interest, or the user has placed the topic-of-interest in a virtual shopping cart). If the user intent exceeds the predetermined threshold, the user is determined to be demonstrating a high level of user intent.

If, at step 314, it is determined that the user intent fails to meet the predetermined threshold, the method reverts back to step 310, and the search session continues to be monitored. On the other hand, if, at step 314, it is determined that the user intent does meet the predetermined threshold, then, at step 316, applications that provide results related to the topic-of-interest are determined by an entity component (such as the entity component 222 of FIG. 2). This may be accomplished by accessing a data store (e.g., the data store 212 of FIG. 2) that includes a mapping between applications residing on the user's device and application capabilities. The user intent with respect to the topic-of-interest is compared to the application capabilities to determine a match. Once a match is determined, the one or more applications associated with the matched application capabilities are identified.

After the applications are determined at step 316, a request is communicated to the applications for application results at step 318. This may be accomplished by a broadcasting component such as the broadcasting component 224 of FIG. 2. Requests may also be communicated to a search engine and/or Web browser for Web-based results that are related to the user intent; the Web-based results may also include advertisements from advertisers associated with the search engine and/or Web browser. Requests may also be communicated to one or more applications that are relevant to the user intent but are currently not residing on the user's device.

The request for results may specify that the results should meet or exceed current results related to the topic-of-interest. For example, suppose a user is currently interested in a particular television model priced at $1,099 on a Web site. The user has exhibited a high degree of user intent by placing the television in a virtual shopping cart and accessing a checkout page of the Web site. The request for results may specify that only those results that price the television for less than $1,099 will be accepted. Alternatively, the request may specify that it will accept an offer of $1,099 but some other incentive should be present such as free shipping. Other examples within the spirit of these examples are contemplated to be within the scope of embodiments of the invention.

At step 320, the results, including the application results, are received from the applications and the search engine. In one aspect, the results may include notifications from applications that are relevant to the user intent but are currently not residing on the user's device. The notifications may inform the user of the existence of applications that can meet the user intent and provide the user an opportunity to download the application and take advantage of the application's capabilities.

At step 322, the application results are aggregated with the Web-based results to form an aggregate set of results. At step 324, the results are ranked by a ranking component such as the ranking component 228 of FIG. 2. In one aspect, the application results are ranked before aggregating the application results with the Web-based results. This ranking may be based on, for example, a purchasing history associated with the applications by the user or by the population in general, the popularity of the application, and/or a rating of the application by an application rating service. In another aspect of the invention, the application results are aggregated with the Web-based results and the aggregate set of results is then ranked. The aggregate set of results may be ranked based on, for example, a click-through rate for the respective each one of the results. This includes the click-through rate of the user as well as the click-through rate of users in the general population. In another aspect, application results within the aggregate set of results may be ranked higher by virtue of the fact that the application results may be more targeted to the user intent with respect to the topic-of-interest.

At step 326, the results are presented on a user interface by a presentation component such as, for example, the presentation component 230 of FIG. 2. The user interface may overlay at least a portion of content of a Web page currently being viewed by the user. In one aspect, only the top four to six results are presented on the user interface. As mentioned above, each of the presented results may be associated with a selectable control that enables the user to select and launch the result. If the result is an application result, the application is launched and the specific feature within the application that is associated with the topic-of-interest is presented. The launched results may be displayed in a user interface that overlays at least a portion of content of a Web page that the user is currently viewing.

One extension of the method 400 is the ability to adjust the pricing of advertisements based on the presence of high user intent. For example, since high user intent likely leads to a greater amount of user action with respect to the presented results, advertisers may be charged a higher amount for those advertisements delivered in response to the high user intent.

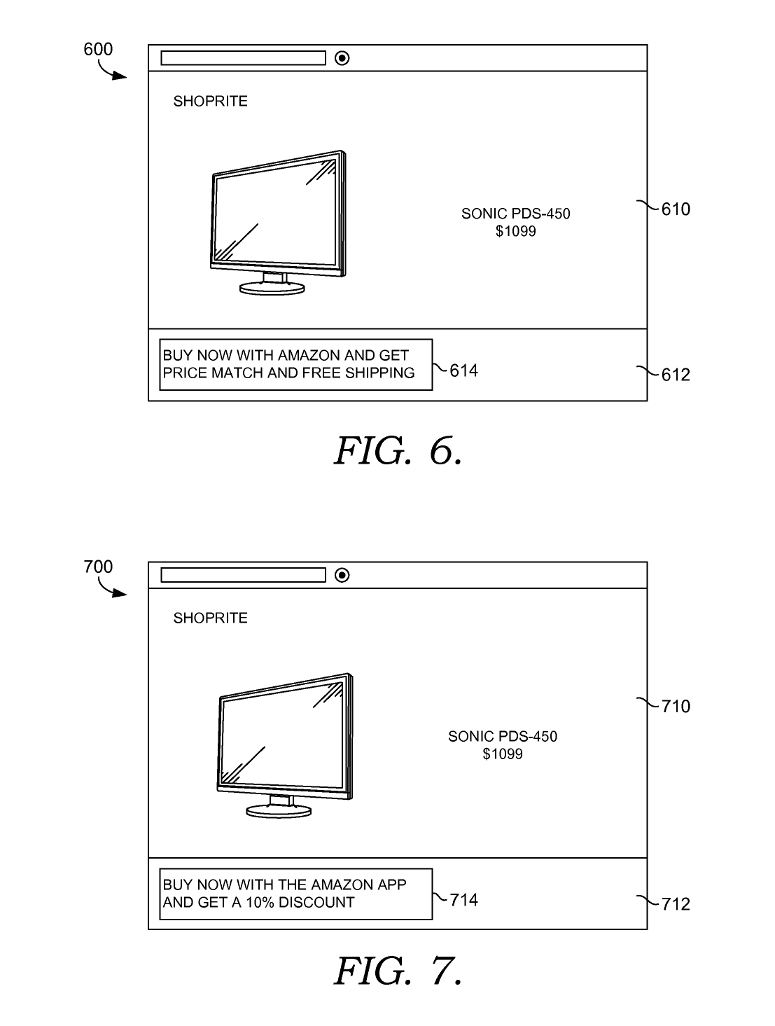

FIG. 6 depicts an exemplary user interface (UI) 600 that is presented to the user upon discerning high user intent with respect to a topic-of-interest. UI 600 includes a Web page 610 that the user is currently viewing. The Web page 610 depicts a television model for which high user intent has been identified. UI 600 also includes UI 612 that is displayed so that it overlays at least a portion of the content of the Web page 610. UI 612 includes one application result 614. As can be seen, the application result 614 meets the current price displayed on the Web page 610 ($1,099), but, additionally, the application result 614 includes an incentive (free shipping) to encourage the user to buy from Amazon® using the Amazon application.

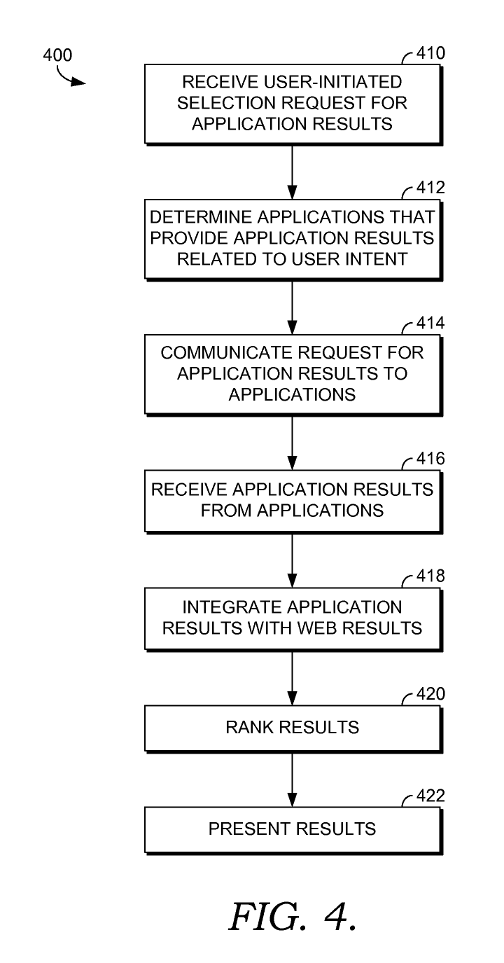

Turning now to FIG. 4, a flow diagram is depicted of a method of broadcasting user intent to applications residing on a user's device upon a user-initiated selection request and subsequently receiving application results. At step 410, the user-initiated selection request is received by a search trigger identification component (such as the search trigger identification component 220 of FIG. 2). The user-initiated selection request may be received upon a user viewing a topic-of-interest on a Web page and selecting, for example, a control button located on a browser bar. Selection of the control button by the user indicates that the user has user intent regarding the topic-of-interest on the Web page.

In one aspect of the invention, once the user has selected the control button, a list of selectable options may be presented that enable the user to limit the scope of user intent. By way of illustrative example, suppose a user is viewing a Web page associated with a restaurant, and the user selects the control button. At this point, a list of selectable options may be presented to the user that includes “Directions?” “Reviews?” and “Reservations?” Depending on which option the user selects, different applications may be determined that best answer the user intent.

Continuing, at step 412, applications residing on the user's device that provide application results related to the user intent are determined, and, at step 414, requests for application results are communicated to the determined applications. At step 416, the application results are received from at least a portion of the applications. For example, although an application may have been determined to provide application results that would meet the user intent, the application may not respond to the request because the application may not have the topic-of-interest currently in stock, may not have information regarding the topic-of-interest, or may not be able to offer a competitive deal.

In one aspect of the invention, the received application results may be specific to the context of the Web page currently being viewed by the user. For example, suppose the user is viewing a Web page from “elgauchorestaurant.com.” The received results may all relate to El Gaucho Restaurant and may include directions, reviews, and the like. In another aspect of the invention, the received application results also may include results related to the general context of the Web page currently being viewed. For example, the results may also include other Mexican restaurants besides El Gaucho Restaurant.

At step 418, the received application results are integrated with any relevant Web-based results related to the topic-of-interest to form an aggregate set of results. At step 420, the aggregate set of results is ranked, and, at step 422, the results are presented to the user on a user interface that overlays at least a portion of content of the Web page currently being viewed by the user. In one aspect, a predetermined number of top-ranked results are presented on the user interface.

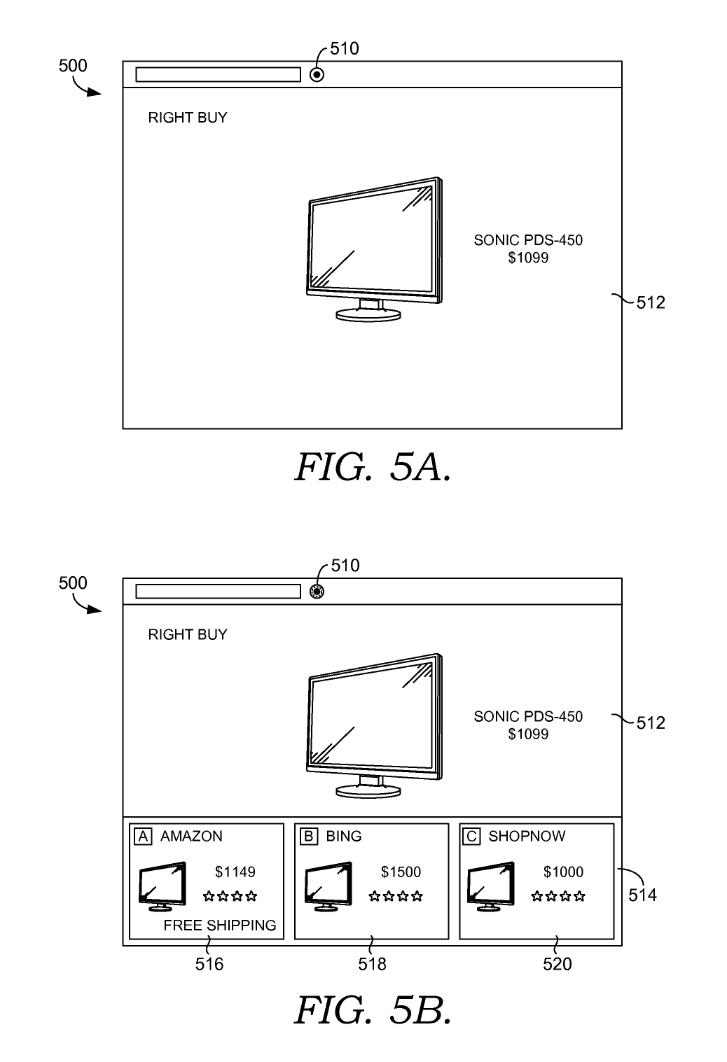

FIGS. 5A and 5B depict two views of an exemplary user interface (UI) 500. FIG. 5A depicts a Web page 512 currently being viewed by the user. The user is looking at a particular television model and desires to know if there are deals that exist related to the television model. The user selects a control button 510 to initiate the method illustrated in FIG. 4. FIG. 5B depicts the same UI 500 after a set of results has been returned. FIG. 5B includes a UI 514 with a set of results. The set of results includes an application result 516, a Web-based result 518, and an advertisement 520. The results 516, 518, and 520 may include, for example, textual elements including a title, as well as an image, and a rating. Each of the results 516, 518, and 520 may also include a selectable option that enables the user to launch the result.

Turning to FIG. 7, an exemplary user interface (UI) 700 is depicted illustrating a notification display indicating the availability of an application that meets user intent with respect to a topic-of interest. The UI 700 includes a Web page 710 that the user is currently viewing. As well, the UI 700 also includes a notification display UI 712. The notification display UI 712 may be displayed to the user upon determining that an application that is relevant to the user intent with respect to a topic-of-interest exists but is currently not residing on the user's device. The notification display UI 712 overlays at least a portion of content of the Web page 710. The notification display UI 712 includes a notification 714 prompting the user to download the Amazon® application in order to take advantage of a favorable offer. The notification 714 is selectable. Upon selection, the application is auto-installed and launched to a feature that is associated with the topic-of-interest.

The present invention has been described in relation to particular embodiments, which are intended in all respects to be illustrative rather than restrictive. Alternative embodiments will become apparent to those of ordinary skill in the art to which the present invention pertains without departing from its scope.

1. One or more computer storage devices having embodied thereon computer-executable instructions that, when executed, perform a method of broadcasting high user intent with respect to a topic-of-interest to one or more applications residing on a user device, the method comprising:
monitoring a user search session on the user device to identify implicit user intent with respect to the topic-of-interest;
determining that the implicit user intent exceeds a predetermined threshold;
based on determining that the implicit user intent exceeds a predetermined threshold, determining one or more applications residing on the user device that provide application results related to the topic-of-interest;
communicating a request to the one or more applications for the application results;
receiving the application results from at least a portion of the one or more applications;
integrating the application results with a set of Web-based results to form an aggregate set of results, the set of Web-based results also related to the user intent;
ranking the aggregate set of results; and
presenting the aggregate set of results on at least a portion of a user interface display.

2. The computer-storage devices of claim 1, wherein monitoring the user search session comprises:
monitoring Web pages viewed by the user; and
monitoring user activity on the Web pages viewed by the user.

3. The computer-storage devices of claim 2, wherein identifying the implicit user intent with respect to the topic-of-interest comprises determining that the user has viewed the topic-of-interest on at least one Web page or that the user has user activity with respect to at least one Web page associated with the topic-of-interest.

4. The computer-storage devices of claim 3, wherein determining that the implicit user intent exceeds the predetermined threshold comprises at least one of the following:
A) determining that the user has user activity directed to or has viewed the topic-of-interest multiple times across multiple Web pages during the user search session,
B) determining that the user has user activity directed to or has viewed the topic-of-interest multiple times on a same Web page during the user search session, or
C) determining that the user is about to purchase the topic-of-interest.

5. The computer-storage devices of claim 1, wherein determining the one or more applications residing on the client device that provide application results related to the topic-of-interest comprises:
accessing an application data store, wherein the application data store includes a mapping between the one or more applications residing on the user device and application capabilities;
comparing the topic-of-interest against the application capabilities to determine a match; and
when a match exists between the topic-of-interest and the application capabilities, identifying the at least one application of the one or more applications associated with the matched application capabilities.

6. The computer-storage devices of claim 1, further comprising:
subsequent to receiving the application results from the one or more applications, ranking the application results, wherein the application results are ranked based on at least one of the following:
A) a number of purchases from the respective one or more applications,
B) a popularity of the respective one or more applications, or
C) a rating from an application rating service for the respective one or more applications.

7. The computer-storage devices of claim 1, wherein the aggregate set of results is ranked based on a click-through rate for each result of the aggregate set of results.

8. The computer-storage devices of claim 7, wherein the click-through rate includes a click-through rate for general users.

9. The computer-storage devices of claim 1, wherein the remaining portion of the user interface display comprises content associated with a Web page currently being viewed by the user.

10. The computer-storage devices of claim 1, further comprising:
subsequent to presenting the aggregate set of results on the at least the portion of the user interface display, receiving a user-initiated selection of at least one result of the aggregate set of results, the at least one result comprising an application result from at least one application;
launching the at least one application on the user device; and
initiating a specific feature within the at least one application, the specific feature associated with the topic-of-interest.

11. The computer-storage devices of claim 1, further comprising:
determining that an application relevant to the topic-of-interest is available but is not installed on the user device; and
based on this determination, prompting the user to install the application on the user device.

12. The computer-storage devices of claim 11, wherein prompting the user to install the application on the user device comprises providing a notification user interface display overlaying at least a portion of content of a Web page currently being viewed by the user.

13. The computer-storage devices of claim 12, further comprising:
receiving a user-initiated selection of the notification user interface display;
auto-installing the application on the user device;
launching the application; and
initiating a specific feature within the application, the specific feature associated with the topic-of-interest.

14. A computerized method carried out by a search service running on a processor for broadcasting user intent with respect to a topic-of-interest to one or more applications residing on a user device, the method comprising:
receiving a user-initiated selection request for application results related to a topic-of-interest on a Web page that the user is currently viewing;
determining, using the processor, one or more applications residing on the user device that provide application results related to the topic-of-interest;
communicating a request to the one or more applications for the application results, the request specifying one or more criteria to be met by the application results, the one or more criteria based on the topic-of-interest on the Web page that the user is currently viewing;
receiving application results meeting the one or more criteria from at least a portion of the one or more applications;
integrating the application results meeting the one or more criteria with a set of Web-based results to form an aggregate set of results, the set of Web-based results also related to the topic-of-interest;
ranking the aggregate set of results; and
presenting the aggregate set of results in a display area, the display area overlaying at least a portion of content of the Web page the user is currently viewing.

15. The method of claim 14, wherein the Web page is generated by a search engine.

16. The method of claim 15, wherein the set of Web-based results comprise at least one of:
A) results from the search engine, or
B) one or more advertisements from advertisers associated with the search engine.

17. The method of claim 14, further comprising:
subsequent to receiving the user-initiated selection request for the application results related to the topic-of-interest, providing the user with a plurality of selectable options for narrowing the scope of user intent; and
receiving a user-initiated selection of at least one of the plurality of selectable options.

18. A computer system for providing application results related to a topic-of-interest, the computer system comprising a processing unit coupled to a computer-storage medium, the computer-storage medium having stored thereon a plurality of computer software components executable by the processing unit, the computer software components comprising:
a monitoring component for monitoring a user-initiated search session and identifying user intent with respect to the topic-of-interest;
a search trigger identification component for identifying at least one search trigger related to the topic-of-interest;
an entity component for determining at least one application that provides application results related to the topic-of-interest;
a broadcasting component for communicating one or more requests for results related to the topic-of-interest, the one or more requests communicated to:
A) the at least one application,
B) a search engine, and
C) one or more advertisers associated with the search engine;
a receiving component for receiving the results related to the user intent;
a ranking component for ranking the results;
a presentation component for presenting the results on a user interface; and
a launching component for launching the at least one application upon a user-initiated selection of at least one of the results, the at least one application launched to a feature within the at least one application that is associated with the topic-of-interest.

19. The system of claim 18, wherein the search trigger comprises at least one of:
A) a user-initiated selection request, or
B) user activity during the user-initiated search session indicating a high degree of user intent with respect to the topic-of-interest.

20. (canceled)
